(19) United States
(12) Patent Application Publication
(10) Pub. No.: US 2012/0016681 A1
(43) Pub. Date: Jan. 19, 2012

(54) SYSTEM, METHOD AND COMPUTER PROGRAM PRODUCT FOR ANALYZING MONITORED USAGE OF A RESOURCE

(75) Inventors: Jesper Joergensen, San Francisco, CA (US); Alex Toussaint, San Francisco, CA (US)

(73) Assignee: salesforce.com, inc., San Francisco, CA (US)

(21) Appl. No.: 13/070,428

(22) Filed: Mar. 23, 2011

Related U.S. Application Data
(60) Provisional application No. 61/363,991, filed on Jul. 13, 2010.

(51) Int. Cl. G06F 15/173; G06Q 30/00

(52) U.S. Cl. 705/1.1; 709/224

(57) ABSTRACT

In accordance with embodiments, there are provided mechanisms and methods for analyzing monitored usage of a resource. These mechanisms and methods for analyzing monitored usage of a resource can enable optimized resource utilization, increased revenue, improved customer satisfaction, more efficient resource allocation, etc.

### CLAIM OF PRIORITY

This application claims the benefit of U.S. Provisional Patent Application 61/363,991, entitled “Methods and Systems for Dynamic Self Service Provisioning in a Multi-tenant Database Environment,” by Joergensen et al., filed Jul. 13, 2010 (Attorney Docket No. SFC1P154+/393PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to system resources, and more particularly to allocating system resources.

### BACKGROUND

The subject matter discussed in the background section should not be assumed to be prior on merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Providing resources to multiple users is a common practice of conventional systems. For example, a multi-tenant system may support multiple users, where each user utilizes a portion of available resources provided by the system. Unfortunately, techniques for allocating system resources to users of the system have been associated with various limitations.

Just by way of example, traditional methods of allocating system resources may provide a static amount of a particular resource to a user of the system. For example, a system may provide a user of the system with a fixed amount of bandwidth that is available to that user for a specific period of time. However, if the fixed amount of the system resource is consumed by the customer, the resource may no longer be provided to the user, which may detrimentally affect the user. Additionally, the customer may not have any means to easily and quickly request an additional allocation of the resource. Accordingly, it is desirable to provide techniques that improve the allocation of system resources.

### BRIEF SUMMARY

In accordance with embodiments, there are provided mechanisms and methods for analyzing monitored usage of a resource. These mechanisms and methods for analyzing monitored usage of a resource can enable optimized resource utilization, increased revenue, improved customer satisfaction, more efficient resource allocation, etc.

In an embodiment and by way of example, a method for analyzing monitored usage of a resource is provided. In one embodiment, an amount of usage of a resource within a system is monitored. Additionally, the monitored usage of the resource is analyzed. Further, one or more actions are performed based on the analyzing.

While one or more implementations and techniques are described with reference to an embodiment in which analyzing monitored usage of a resource is implemented in a system having an application server providing a front end for an on-demand database system capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for analyzing monitored usage of a resource, in accordance with one embodiment;

FIG. 2 illustrates an exemplary self service provisioning system, in accordance with another embodiment;

FIG. 3 illustrates a block diagram of an example of an environment wherein an on-demand database system might be used; and

FIG. 4 illustrates a block diagram of an embodiment of elements of FIG. 4 and various possible interconnections between these elements.

### DETAILED DESCRIPTION

### General Overview

Systems and methods are provided for analyzing monitored usage of a resource.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for analyzing monitored usage of a resource will be described with reference to example embodiments.

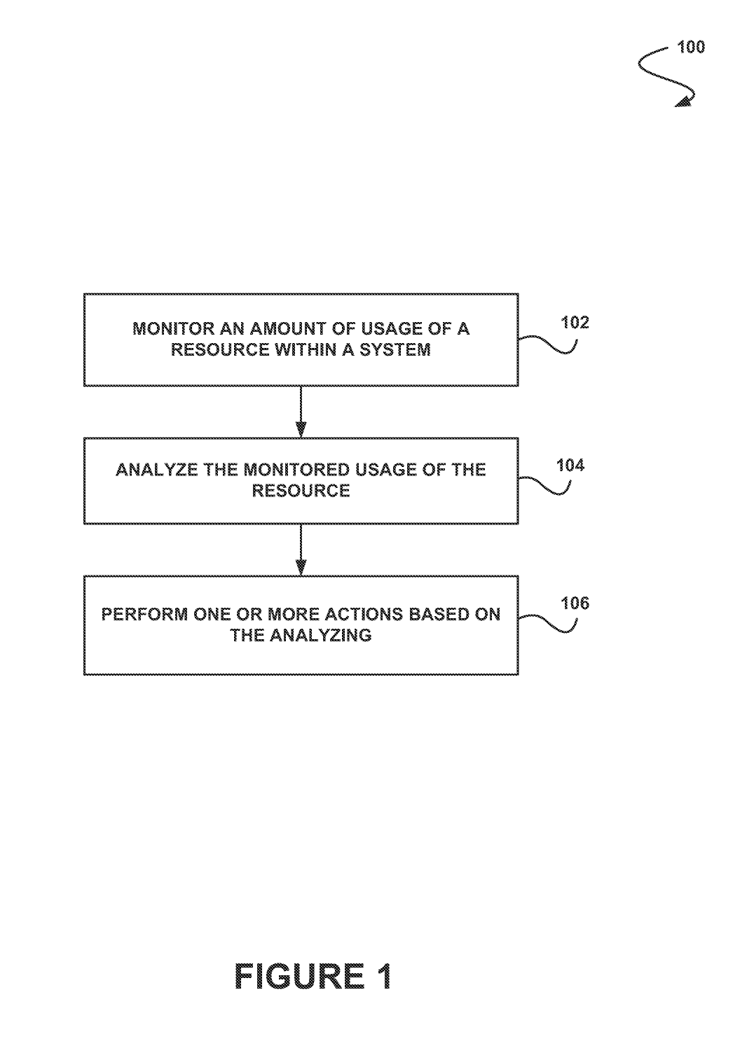

FIG. 1 illustrates a method 100 for analyzing monitored usage of a resource, in accordance with one embodiment. As shown in operation 102, an amount of usage of a resource within a system is monitored. In one embodiment, the system may include a client, a server, a multi-tenant on-demand database system, etc. In another embodiment, the resource may include any element of the system that can be allocated to one or more entities (e.g., one or more individuals, companies, customers, etc.). For example, the resource may include one or more of hard drive space within the system, database space provided by the system, bandwidth provided by the system, application programming interface (API) calls provided by the system API batch calls to the system, calls to a database of the system, software provided by the system, or any other options or allowances provided by the system.

Additionally, in one embodiment, a limited portion of the resource may be allotted to one or more entities by the system. For example, the system may allocate a predetermined number of API calls to each customer of the system. In another embodiment, the system may allocate the portion of the resource to the one or more entities for a predetermined period of time (e.g., a day, a week, a month, a year, etc.). For example, an entity may be given a predetermined amount of bandwidth each day for a month-long time period. In yet another embodiment, the one or more entities may pay a fee for the use of the portion of the resource within the system. For example, the one or more entities may subscribe to a service that provides the resource.

Further, in another embodiment, monitoring the amount of usage of the resource may include observing one or more elements of the system. For example, monitoring the amount of usage of the resource may include accessing one or more logs associated with the usage of the resource (e.g., a rate of consumption of the resource, a history of the usage of the resource, etc.). In another example, monitoring the amount of usage of the resource may include observing and recording one or more changes in the system.

In another embodiment, monitoring the amount of usage of the resource may be performed by an element of the system. For example, monitoring the amount of usage of the resource may be performed by a monitoring module (e.g., a software module, a hardware module, an active monitoring module, etc.). In yet another embodiment, the usage of the resource may be determined with respect to an entity. For example, an individual customer's usage may be monitored. In still another embodiment, the amount of usage may be monitored for a predetermined period of time. For example, the monitored usage may include the usage of the resource that is determined within an hour, a day, a month, etc.

Additionally, it should be noted that, as described above, such multi-tenant on-demand database system may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database system will be set forth in the context of different embodiments that will be described during reference to subsequent figures.

Furthermore, as shown in operation 104, the monitored usage of the resource is analyzed. In one embodiment, analyzing the monitored usage may include comparing the monitored usage against a threshold. For example, it may be determined whether a limit has been associated with the allotted usage of an entity, and the determined amount of usage of the resource may be compared against that limit. In this way, it may be determined whether the usage of the resource is nearing its associated limit.

In another embodiment, additional availability of the resource within the system may be determined. For example, if the resource includes system bandwidth, the system may be queried and it may be determined whether additional system bandwidth is currently available, available at a future time period, etc. In yet another embodiment, the monitored usage may be compared against one or more rules. For example, the rules may include one or more dynamic rules (e.g., created by the entity, by the system, by an administrator, etc.) that perform one or more actions based on a predetermined amount of usage of the resource.

Further still, in one embodiment, analyzing the monitored usage may include predicting a future amount of usage based on the monitored amount of usage. For example, the future amount of usage may be predicted for a particular amount of time (e.g., a day, a week, a month, etc.). In another embodiment, analyzing the monitored usage may include predicting when the resource will be exhausted based on the monitored usage. For example, if an entity is allotted a limited amount of the resource within the system, a time when such limited amount will be used may be determined.

Additionally, in another embodiment, analyzing the monitored usage may include displaying the monitored usage to an entity. For example, the monitored usage may be summarized, and the summary may be provided to the entity, such that the entity can review their usage of the resource (e.g., in order to determine whether to request an additional resource allotment, etc.).

Also, as shown in operation 106, one or more actions are performed based on the analyzing. In one embodiment, performing the one or more actions may include allotting an additional portion of the resource. For example, if it is determined that the amount of usage of the resource by an entity would result in a premature exhaustion of the resource (e.g., exhaustion of the resource before a period of time associated with that resource has passed, etc.), and it is also determined that additional portions of the resource are available, then an additional portion of the resource (e.g., a percentage of the current allotment, a percentage of the available allotment, etc.) may be provided to the entity (e.g., automatically, with the approval of the entity, etc.). In another embodiment, performing the one or more actions may include billing an entity for the additional portion of the resource that they are allotted.

In another example, if it is determined from monitoring an amount of API calls made to access data of a particular client that the client may run out of API calls by a particular time, then it may be determined whether the client has agreed to purchase more API calls as necessary (e.g., by setting a dynamic rule stating that more API calls may be purchased), and it may also be determined whether the client is capable of purchasing such API calls (e.g., the client account is not past due, etc.). Additionally, the system may be queried to determine if additional API calls are available. Further, the additional required API calls may then be automatically provisioned to the entity.

In yet another embodiment, performing the one or more actions may include displaying data associated with the resource usage to an entity. For example, the amount of usage monitored within the system may be summarized and provided to the entity. In another example, the entity may be alerted (e.g., via an electronic mail message, a GUI pop-up message, etc.) that their amount of usage of the resource may result in a premature exhaustion of the resource if such exhaustion is suggested by the analyzing of the monitored usage (e.g., via an electronic mail message, pop-up window in a graphical user interface, etc.). In yet another example, the entity may be alerted before an additional portion of the resource is allotted to the entity. In still another embodiment, the entity may be provided with one or more potential actions to be taken based on the monitored amount of usage. For example, the entity may be provided with an option to approve or deny the receipt of the additional portion of the resource. In this way, the entity may self-regulate their usage of the resource.

Additionally, in one embodiment, the one or more actions may be performed according to one or more rules. For example, an entity, the system, an individual, etc. may create one or more rules that permit one or more actions to be performed based on the monitored amount of usage. In another embodiment, the one or more rules may be associated with a particular entity. For example, the one or more rules may be associated with the resource usage of a particular customer. In this way, usage of the resource may be dynamically monitored and adjusted, thereby maximizing resource usage while eliminating downtime associated with the unavailability of the resource due to exceeding an allotted resource amount.

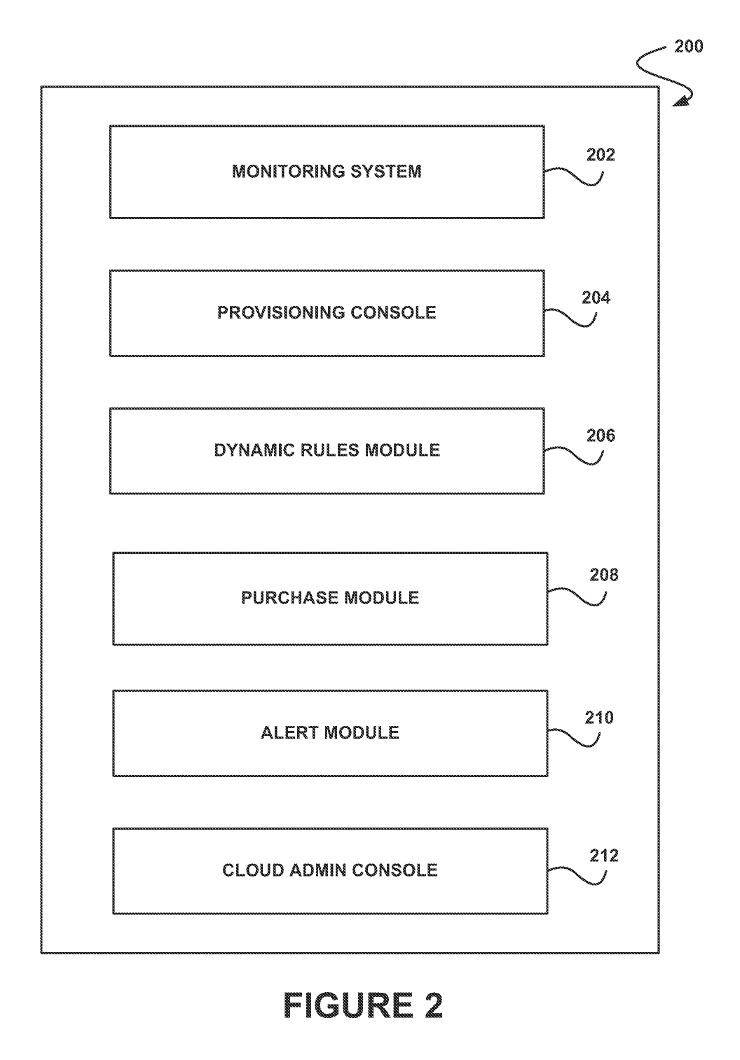

FIG. 2 illustrates an exemplary self service provisioning system 200, in accordance with another embodiment. As an option, the present system 200 may be carried out in the context of the functionality of FIG. 1. Of course, however, the system 200 may be carried out in any desired environment. The aforementioned definitions may apply during the present description.

As shown, the self service provisioning system 200 includes a monitoring system 202. In one embodiment, the monitoring system 202 may include a network of agents that capture important system resource utilization data across a cloud (e.g., a cloud infrastructure, a multi-tenant on-demand database system, etc.). In another embodiment, the captured data may be stored and made available to other provisioning modules of the self service provisioning system 200. In yet another embodiment, the data may be updated frequently and may portrait a close-to-real-time picture of the cloud.

Additionally, the self service provisioning system 200 includes a provisioning console 204. In one embodiment, the provisioning console 204 may expose one or more current snap shots of the cloud resources from the monitoring system 202. For example, the utilization data captured by the monitoring system 202 may represent the current system utilization in the cloud at a particular point. In another embodiment, a full or partial view of such data may be provided to customers depending on one or more factors (e.g., service type, etc.). In yet another embodiment, one or more end users may use the provisioning console 204 to manually provision new resources as needed in order to allow the end users to complete a particular task.

Further, in another embodiment, an acceptance process may takes place in order to confirm a user request, much like of a financial transaction. In yet another embodiment, upon confirmation and availability, the additional capacity may be made available (e.g., at a particular price, etc). For example, users may need additional processing capacity to load 50 million records, and via the provisioning console 204 they may quickly review cloud status, and provision additional amounts of capacity.

Further still, the self service provisioning system 200 includes a dynamic rules module 206. In one embodiment, inside the provisioning console 204, users may add rules to dynamically add more capacity, such that automatic provisioning may be available with automatic approval. For example, out of the box rules maybe set to increase resource capacity by 5% or 10%, if systems resources permit, for a particular user in order to get a process done. In another embodiment, the rules may indicate that actions may be blocked depending on the type of customer.

Also, the self service provisioning system 200 includes a purchase module 208. In one embodiment, the purchase module may allow one or more users to procure additional resources for their cloud operation. In one embodiment, the option to procure additional resources may note may or may not be available, depending on the customer. In another embodiment, a large customer may negotiate an amount of credit in their account, so that procurement of additional resources may be allowed. This may be done manually, or by following one or more rules described in the dynamic rules module 206.

In addition, the self service provisioning system 200 includes an alert module 210. In one embodiment, as cloud resources get consumed, users may want to set up alerts to help them complete a particular process. We may have several types of alerts (e.g., at different thresholds, etc.). Furthermore, the self service provisioning system 200 includes a cloud administrator console 212. In one embodiment, the cloud administrator console 212 may allow an administrator of the cloud to see in detail information associated with provisioning throughout the cloud (e.g., the current and historic provisioning actions across all users, etc.). In another embodiment, the cloud administrator console 212 may also allow for alerts and reporting capabilities.

Furthermore, in another embodiment, one or more users may be able to provision additional resources in the cloud. For example, the users may set up rules to dynamically enable capacity as needed to their applications. In another embodiment, one or more users may set up alerts to provide operation visibility and emergency support. In yet another embodiment, one or more users may procure additional resources from the cloud manually, dynamically from the Internet, via a mobile device, via an API interface, or by any other means. Also, in another embodiment, users may see complete system status and resource availability in the cloud (e.g., via a summary display, etc.). In this way, the self service provisioning system 200 may allow one or more users to dynamically procure resources for applications in the cloud. Additionally, the self service provisioning system 200 may enable users and administrators to be aware of the available and used resources of the cloud, and to avoid time-consuming correspondence associated with manual allocation of resources.

### System Overview

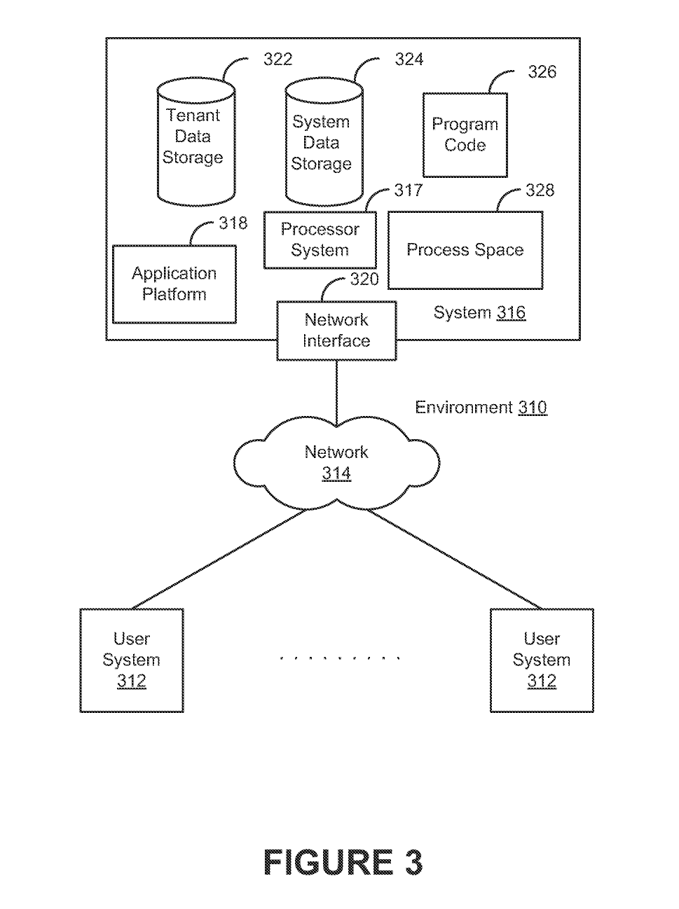

FIG. 3 illustrates a block diagram of an environment 310 wherein an on-demand database system might be used. Environment 310 may include user systems 312, network 314, system 316, processor system 317, application platform 318, network interface 320, tenant data storage 322, system data storage 324, program code 326, and process space 328. In other embodiments, environment 310 may not have all of the components listed and/or may have other elements instead of, or in addition to, those listed above.

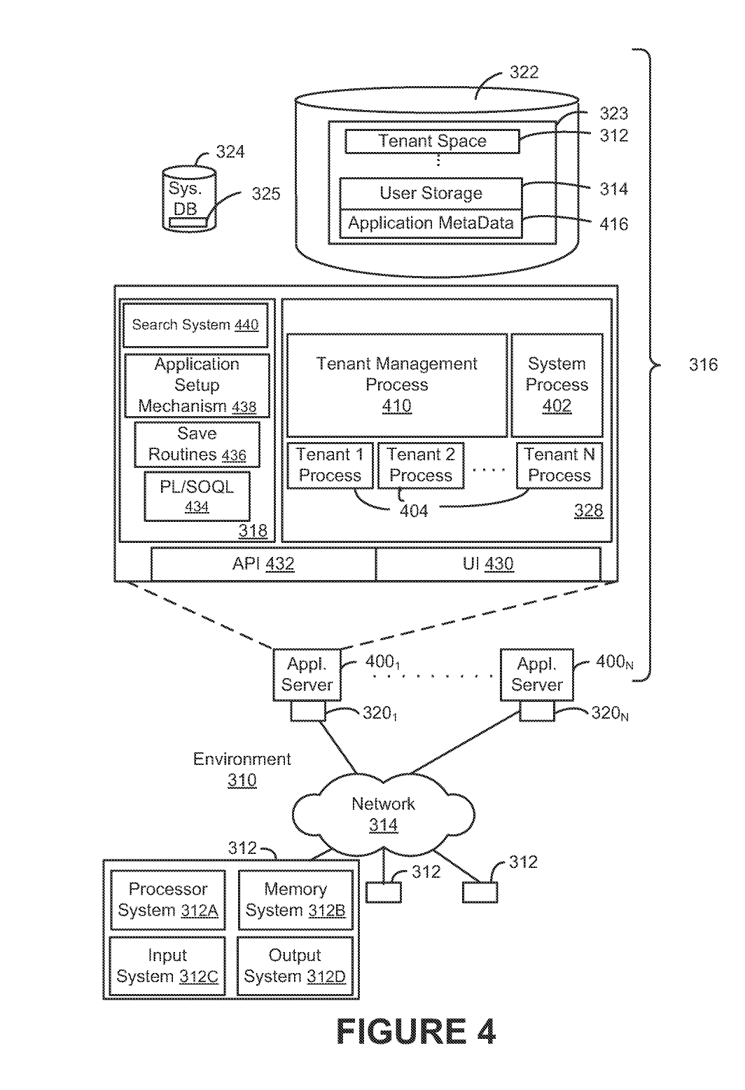

Environment 310 is an environment in which an on-demand database system exists. User system 312 may be any machine or system that is used by a user to access a database user system. For example, any of user systems 312 can be a handheld computing device, a mobile phone, a laptop computer, a work station, and/or a network of computing devices. As illustrated in FIG. 3 (and in more detail in FIG. 4) user systems 312 might interact via a network 314 with an on-demand database system, which is system 316.

An on-demand database system, such as system 316, is a database system that is made available to outside users that do not need to necessarily be concerned with building and/or maintaining the database system, but instead may be available for their use when the users need the database system (e.g., on the demand of the users). Some on-demand database systems may store information front one or more tenants stored into tables of a common database image to form a multi-tenant database system (MTS). Accordingly, “on-demand database system 316” and “system 316” will be used interchangeably herein. A database image may include one or more database objects. A relational database management system (RDMS) or the equivalent may execute storage and retrieval of information against the database object(s). Application platform 318 may be a framework that allows the applications of system 316 to run, such as the hardware and/or software, e.g., the operating system. In an embodiment, on-demand database system 316 may include an application platform 318 that enables creation, managing and executing one or more applications developed by the provider of the on-demand database system, users accessing the on-demand database system via user systems 312, or third party application developers accessing the on-demand database system via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 312 might communicate with system 316 using TCP/IP and, at a higher network level, use other common Internet protocols to communicate, such as HTTP, FTP, AFS, WAP, etc. In an example where HTTP is used, user system 312 might include an HTTP client commonly referred to as a “browser” for sending and receiving HTTP messages to and from an HTTP) server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MIS' data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as provide related data, code, forms, webpages and other information to and from user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 316 implements applications other than, or in addition to, a CRM application. For example, system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MTS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 312 to access, process and view information, pages and applications available to it from system 316 over network 314. Each user system 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 316 or other systems or servers. For example, the user interface device can be used to access data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Pentium® processor or the like. Similarly, system 316 (and additional instances of an MTS, where more than one is present) and all of their components might be operator configurable using application(s) including computer code to run using a central processing unit such as processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code fir operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates environment 310. However, in FIG. 4 elements of system 316 and various interconnections in an embodiment are further illustrated. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, User Interface (UI) 430, Application Program Interface (API) 432, PL/SOQL 434, save routines 436, application setup mechanism 438, applications servers 400₁-400_{N}, system process space 402, tenant process spaces 404, tenant management process space 410, tenant storage area 412, user storage 414, and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3. Regarding user system 312, processor system 312A may be any combination of one or more processors. Memory system 312B may be any combination of one or more memory devices, short term, and/or long term memory. Input system 312C may be any combination of input devices, such as one or more keyboards, mice, trackballs, scanners, cameras, and/or interfaces to networks. Output system 312D may be any combination of output devices, such as one or more monitors, printers, and/or interfaces to networks. As shown by FIG. 4, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage areas 412, which can be either a physical arrangement and/or a logical arrangement of data. Within each tenant storage area 412, user storage 414 and application metadata 416 might be similarly allocated for each user. For example, a copy of a user's most recently used (MRU) items might be stored to user storage 414. Similarly, a copy of MRU items for an entire organization that is a tenant might be stored to tenant storage area 412. A UI 430 provides a user interface and an API 432 provides an application programmer interface to system 316 resident processes to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410 for example. Invocations to such applications may be coded using PL/SOQL 434 that provides a programming language style interface extension to API 432. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 416 for the subscriber making the invocation and executing the metadata as an application in a virtual machine.

Each application server 400 may be communicably coupled to database systems, e.g., having access to system data 325 and tenant data 323, via a different network connection. For example, one application server 400₁ might be coupled via the network 314 (e.g., the Internet), another application server 400_{N-1} might be coupled via a direct network link, and another application server 400_{N} might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

in certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles storage of, and access to, different objects, data and applications across disparate users and organizations.

As an example of storage, one tenant might be a company that employs a sales force where each salesperson uses system 316 to manage their sales process. Thus, a user might maintain contact data, leads data, customer follow-up data, performance data, goals and progress data, etc., all applicable to that user's personal sales process (e.g., in tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

in certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more SQL statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product embodied on a tangible computer readable medium, comprising;
computer code for monitoring an amount of usage of a resource within a system;
computer code for analyzing the monitored usage of the resource; and
computer code for performing one or more actions based on the analyzing.

2. The computer program product of claim 1, wherein the system includes a multi-tenant on-demand database system.

3. The computer program product of claim 1, wherein the resource includes one or more of hard drive space within the system, database space provided by the system, bandwidth provided by the system, application programming interface (API) calls provided by the system, calls to a database of the system, and software provided by the system.

4. The computer program product of claim 1, wherein the computer program product is operable such that a limited portion of the resource is allotted to one or more entities by the system.

5. The computer program product of claim 4, wherein the computer program product is operable such that the system allocates the portion of the resource to the one or more entities for a predetermined period of time.

6. The computer program product of claim 4, wherein the computer program product is operable such that the one or more entities pay a fee for the use of the portion of the resource within the system.

7. The computer program product of claim 1, wherein monitoring the amount of usage of the resource includes accessing one or more logs associated with the usage of the resource.

8. The computer program product of claim 1, wherein monitoring the amount of usage of the resource is performed by a monitoring module.

9. The computer program product of claim 1, wherein the computer program product is operable such that an individual customer's usage is monitored.

10. The computer program product of claim 1, wherein the computer program product is operable such that the amount of usage is monitored for a predetermined period of time.

11. The computer program product of claim 1, wherein analyzing the monitored usage includes comparing the monitored usage against a threshold.

12. The computer program product of claim 1, further comprising computer code for determining additional availability of the resource within the system.

13. The computer program product of claim 1, further comprising computer code for comparing the monitored usage against one or more rules.

14. The computer program product of claim 13, wherein the rules include one or more dynamic rules that perform one or more actions based on a predetermined amount of usage of the resource.

15. The computer program product of claim 1, wherein analyzing the monitored usage includes predicting when the resource will be exhausted based on the monitored usage.

16. The computer program product of claim 1, wherein performing the one or more actions includes allotting an additional portion of the resource.

17. The computer program product of claim 1, wherein the computer program product is operable such that if it is determined that the amount of usage of the resource by an entity would result in a premature exhaustion of the resource, and it is also determined that additional portions of the resource are available, then an additional portion of the resource is provided to the entity.

18. The computer program product of claim 1, wherein performing the one or more actions includes displaying data associated with the resource usage to an entity.

19. A method, comprising:
monitoring an amount of usage of a resource within a system;
analyzing the monitored usage of the resource; and
performing one or more actions based on the analyzing.

20. An apparatus, comprising:
a processor for:
monitoring an amount of usage of a resource within a system;
analyzing the monitored usage of the resource; and
performing one or more actions based on the analyzing.

21. A method for transmitting code for use in a multi-tenant database system on a transmission medium, the method comprising:
transmitting code for monitoring an amount of usage of a resource within a system;
transmitting code for analyzing the monitored usage of the resource; and
transmitting code for performing one or more actions based on the analyzing.
